(19) United States
(12) Patent Application Publication
(10) Pub. No.: US 2018/0364773 A1
(43) Pub. Date: Dec. 20, 2018

(54) Electronic Device

(71) Applicant: Quanta Computer Inc., Taoyuan City (TW)

(72) Inventors: Yen-Kuan Lu, Taoyuan City (TW); Hui-Chi Hsu, Taoyuan City (TW); Yu-Chun Wang, Taoyuan City (TW)

(21) Appl. No.: 15/688,074

(22) Filed: Aug. 28, 2017

(30) Foreign Application Priority Data
Jun. 15, 2017 (TW) 106120013

(51) Int. Cl. G06F 1/20

(52) U.S. Cl. CPC G06F 1/203

(57) ABSTRACT

An electronic device includes a bottom plate, a heat pipe, a battery assembly, and a heat dissipation layer. The heat pipe is disposed along the bottom plate. The battery assembly is disposed on the bottom plate. The heat dissipation layer is disposed between the heat pipe and the bottom plate and extends between the battery assembly and the bottom plate.

### CROSS-REFERENCE TO RELATED APPLICATION

This application claims priority to Taiwan Application Serial Number 106120013, filed Jun. 15, 2017, which is herein incorporated by reference.

### BACKGROUND

### Field of Invention

The present disclosure relates to a dissipated electronic device including a heat pipe and a heat dissipation layer.

### Description of Related Art

In general, in order to prevent an occurrence of temporary or permanent failure of an electronic device due to the overheating of electronic components inside the electronic device, it is common to dispose a fan in the electronic device adjacent to the electronic components which may possess high temperatures, such as a power supply, a central processing unit (CPU), or a graphics processing unit (GPU), for heat dissipation or to remove thermal energy generated from the electronic components at high speed operation, and thereby lowering temperature of the electronic components. As such, the operation of the electronic device can be smoother. However, the rotation of the fan will produce vibration or noise, and when frequencies of the vibration noise falls within a receiving range of the human ear, it may affect the user's listening experience, which may affect the user's operational comfort.

In addition, because a design of electronic devices continues in the trend of having reduced thickness and volume thereof, the use of a fan may be limited. Therefore, how to effectively reduce noise generated from the fan components, or reduce the thermal energy generated from the electronic components in a limited space is the problem faced by the person having ordinary skill in the art.

### SUMMARY

In view of the aforementioned problem, the present disclosure provides a dissipated electronic device including a heat pipe and a heat dissipation layer.

The present disclosure provides an electronic device. An electronic device includes a bottom plate, a heat pipe, a battery assembly, and a heat dissipation layer. The heat pipe is disposed along the bottom plate. The battery assembly is disposed on the bottom plate. The heat dissipation layer is disposed between the heat pipe and the bottom plate and extends between the battery assembly and the bottom plate.

In the aforementioned configurations, the heat pipe of the present disclosure is designed to be a closed loop, and the heat dissipation layer is disposed under the heat dissipation portion of the heat pipe and has a good thermal conductivity, thereby enabling the heat dissipation layer to disperse a thermal energy of the dissipation portion at least uniformly between the battery assembly and the bottom plate by the space therebetween. Therefore, the housing of the electronic device may have a small temperature difference at different locations thereof. When the user operates the electronic device 1, the body feel of the electronic device 1 can be more comfortable. Furthermore, because the heat dissipation portion of the heat pipe is located outside of the battery assembly (that is, the heat pipe is without surrounding the battery assembly) and the thermal energy absorbed by the heat pipe can be transmitted at least between the battery assembly and the bottom plate via the heat dissipation layer, thereby shortening the length of the heat pipe to lower the space occupied by the heat pipe. Therefore, the electronic device of the present disclosure can increase a utilization rate of its internal space. For example, in the electronic device, the additional space added by the setting of the heat pipe can be used to increase a volume and/or capacity of the battery assembly of the electronic device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of an electronic device in accordance with some embodiments of the present disclosure;

FIG. 2 is a top view of a partial components of the electronic device in accordance with some embodiments of the present disclosure;

FIG. 3 is a cross-sectional view along line 2-2 in FIG. 2.

FIG. 4 a partial enlarged perspective view of the electronic device in accordance with some embodiments of the present disclosure; and

FIG. 5 is another partial enlarged perspective view of the electronic device in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

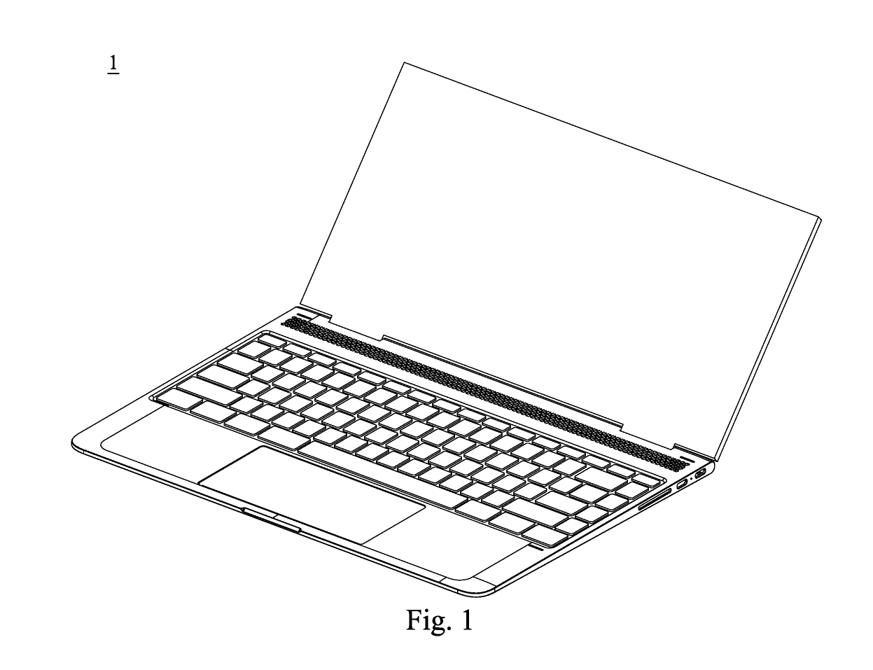

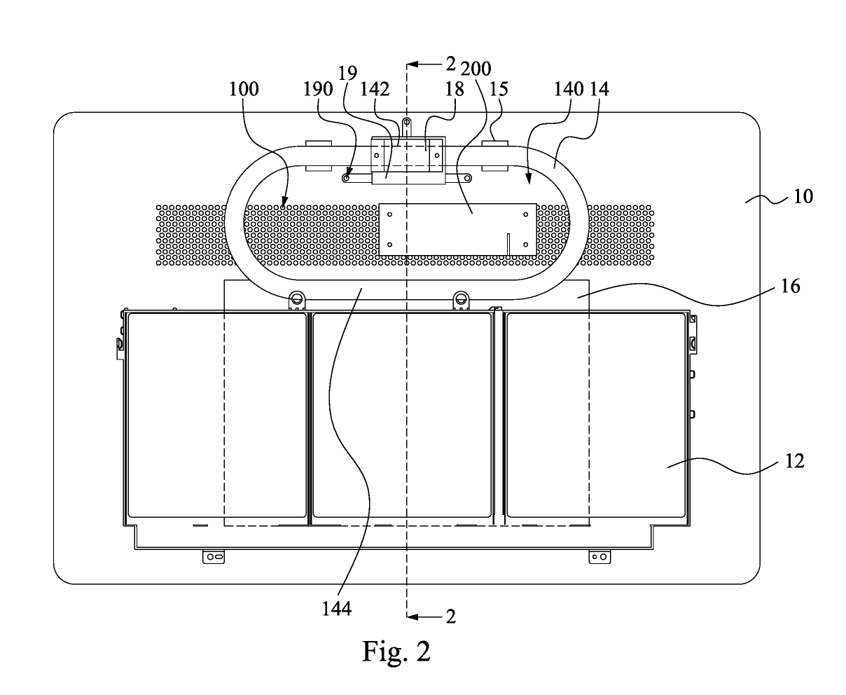

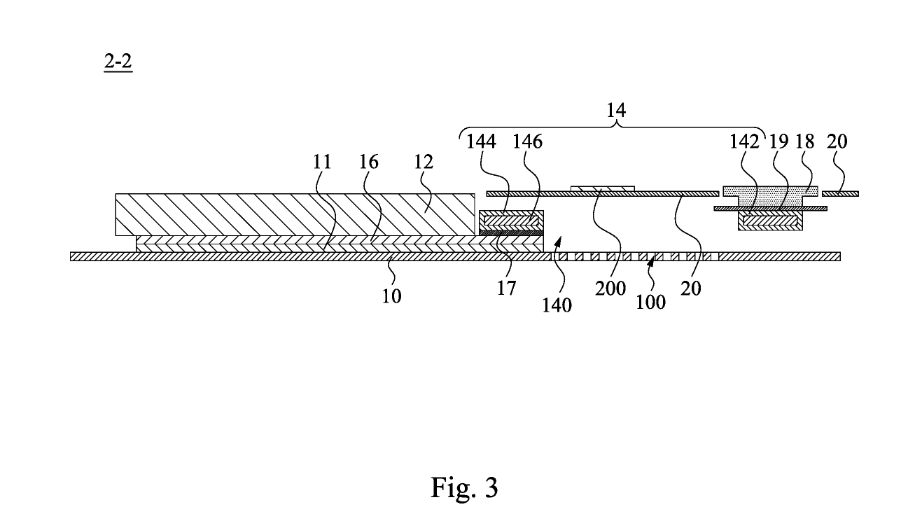

Reference is made to FIGS. 1, 2, and 3. FIG. 1 is a perspective view of an electronic device 1 in accordance with some embodiments of the present disclosure. FIG. 2 is a top view of partial structures of the electronic device 1 in accordance with some embodiments of the present disclosure. FIG. 3 is a cross-sectional view along line 2-2 in FIG. 2. In order to better understand the present disclosure, FIG. 2 is illustrated to omit a circuit board 20 shown in FIG. 3. In the present disclosure, the electronic device 1 is a notebook or a tablet computer, but the present disclosure is not limited thereto. In other embodiments, any suitable electronic device can be applied to the present disclosure.

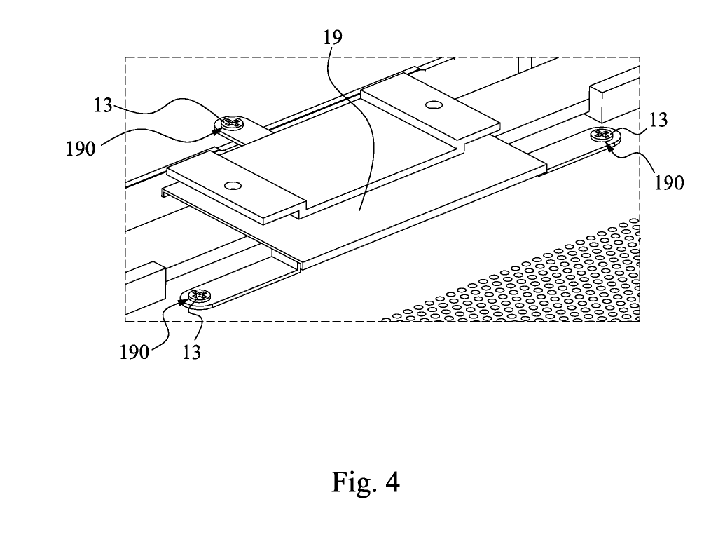

As shown in FIGS. 2 and 3, in the embodiment, the electronic device 1 includes a bottom plate 10, a heat dissipation layer 16, an adhesive layer 17 (see FIG. 3), a heat pipe 14, a heat sink 19, a heating device 18, circuit board 20 (see FIG. 3), a battery assembly 12, a fixing member 13 (see FIG. 4), and an elastic structure 15. The structure and function of the components and their relationships are described in detail hereinafter.

In FIG. 2, the bottom plate 10 of the electronic device 1 has a plurality of through holes 100. The bottom plate 10 is substantially in contact with a portion of a plane, such as, a desktop. The through holes 100 of the bottom plate 10 communicate an inner of the electronic device 1 to outside. In the embodiment, the bottom plate 100 is made of metal, such as, aluminum or aluminum-magnesium alloy, but the present disclosure is not limited thereto. The heat dissipation layer 16 of the present disclosure is disposed on the bottom plate 10, and connects to the bottom plate 10 via a filling material layer 11 (see FIG. 3). The heat dissipation layer 16 has good thermal conductivity, and is made of metal, such as, copper, but the present disclosure is not limited thereto.

In the embodiment, the heat pipe 14 is a closed loop of metal chamber, has a heat absorbing portion 142 and a heat dissipation portion 144, and includes a flowable fluid 146 (see FIG. 3) therein. Furthermore, by means of a two-phase (i.e., liquid phase and vapor phase) change in the continuous circulation of the flowable fluid 146 and by means of the convection of the flowable fluid 146 (i.e., a liquid flowable fluid and a vapored flowable fluid) between the heat absorbing portion 142 and the heat dissipation portion 144 of the heat pipe 14, thereby the heat pipe 14 of the present disclosure can achieve the effect of conducting the heat in the electronic device 1. In the embodiment, the liquid flowable fluid 146 flows from the heat absorbing portion 142 to the heat dissipation portion 144, and the vapored flowable fluid 146 flows form the heat dissipation portion 144 to the heat absorbing portion 142.

In practice, because the heat absorbing portion 142 of the heat pipe 14 can absorb a thermal energy, such that a liquid flowable fluid 146 in the heat absorbing portion 142 evaporates into a vapored flowable fluid 146. In the meantime, a local high pressure can be generated in the chamber of the heat pipe 14, thereby enabling the vapored flowable fluid 146 to be driven to flow to the heat dissipation portion 144 of the heat pipe 14. Then, the vapored flowable fluid 146 in the heat dissipation portion 144 of the heat pipe 14 can be condensed into the liquid flowable fluid 146 for releasing the thermal energy, and the liquid flowable fluid 146 can be returned to the heat absorbing portion 142 of the heat pipe 14 by force, such as, gravity, capillary force or centrifugal force, and then the aforementioned action is in the continuous circulation for the thermal conductivity.

In the FIGS. 2 and 3, the heat pipe 14 of the present disclosure is disposed along the bottom plate 10 and partially overlaps with the heat dissipation layer 16. Specifically, the heat dissipation portion 144 of the heat pipe 14 is disposed on the heat dissipation layer 16, and connects to the heat dissipation layer 16 via the adhesive layer 17 (see FIG. 3). In other words, the heat dissipation layer 16 of the present disclosure is disposed between the heat dissipation portion 144 of the heat pipe 14 and the bottom plate 10, and the adhesive layer 17 is adhesive between the heat dissipation portion 144 of the heat pipe 14 and the heat dissipation layer 16. As such, the adhesive layer 17 can transmit a thermal energy of the heat dissipation portion 144 to the heat dissipation layer 16 efficiently, and then the heat dissipation layer 16 with good thermal conductivity can transmit the thermal energy to the bottom plate 10 to remove the thermal energy from the electronic device 1.

Specifically, the heat pipe 14 of the present disclosure surrounds to form a heat dissipation space 140 within an inner circumferential edge thereof to form a closed loop of a cooling device. The heat absorbing portion 142 and the heat dissipation portion 144 of the heat pipe 14 are located at opposite sides of the closed loop, and the heat dissipation space 140 is located between the heat absorbing portion 142 and the heat dissipation portion 144. The heat absorbing portion 142 of the heat pipe 14 is locate at a side of the heat dissipation space 140 away from the heat dissipation portion 144 and the heat dissipation layer 16. In the embodiment, the heat dissipation space 140 of the heat pipe 14 can be referred to as a heat storage tank, and the heat dissipation space 140 communicates to outside of the electronic device 1 via the through holes 100 of the bottom plate 10. Hence, in a process of the transmission of the thermal energy of the heat pipe 14, a part of the thermal energy is accumulated in the heat dissipation space 140, and then the part of the thermal energy is transmitted to outside of the electronic device 1 via the through holes 100 of the bottom plate 10.

In an example, all of the through holes 100 are located in the heat dissipation space 140. In another example, a part of the through holes 100 are located in the heat dissipation space 140.

As such, the heat pipe 14 is designed as the closed loop, and has a closed and directional heat transmission effect. Furthermore, in the case where the fan is not provided in the electronic device 1, the heat pipe 14 can transmit the thermal energy from a high temperature area to a low temperature area, and can improve heat conduction efficiency, thereby enabling entire system of the electronic device 1 to reach a uniform temperature. For example, the heat pipe 14 of the present disclosure can help convey the heat generated from a chip located in the electronic device 1, thereby decreasing temperature of the chip to improve time of a service life and/or performance of the chip.

Furthermore, because the heat pipe 14 is disposed in the electronic device 1, the electronic device 1 can save the manufacturing cost without having to set the fan therein. Moreover, in the forgoing configuration, the electronic device 1 can avoid the noise generated from the fan during operation, and it is not necessary to provide power required for operating a fan so as to achieve the effect of saving power.

In FIGS. 2 and 3, the heat sink 19 covers the heat absorbing portion 142 of the heat pipe 14. In other words, the heat absorbing portion 142 of the heat pipe 14 is disposed between the heating device 18 and the bottom plate 10, and the heat sink 19 is disposed between the heating device 18 and the heat absorbing portion 142 of the heat pipe 14 for tightening the heat absorbing portion 142 more closely to the heating device 18 to improve the heat transmission efficiency. In the embodiment, the heating device 18 is central processing unit (CPU). However, the present disclosure is not limited thereto, any electronic device that generates heat can be applied in the present disclosure.

Reference is made to FIG. 3, in the embodiment, the circuit board 20 of the electronic device 1 is located on the heat dissipation space 140 of the heat pipe 14, includes electronic component 200, and further defines the heat dissipation space 140 of the present disclosure. That is, the heat dissipation space 140 is defined by the inner circumferential edge of the heat pipe 14, bottom plate 10, and the circuit board 20. Furthermore, the electronic component 200 disposed on the circuit board 20 is aligned with the heat dissipation space 140. The electronic component 200 of the present disclosure can be a memory device, but the present disclosure is not limited thereto. Moreover, the electronic component 200 of the present disclosure is only depicted as one. However, in other embodiments, a quantity of the electronic component 200 can be plural, and the type of each one of the plural electronic devices 200 can be designed depending on the actual application requirements.

The thermal energy absorbed by the heat dissipation portion 144 of the heat pipe 14 can transmit to the heat dissipation layer 16, then transmit to the bottom plate 10 through the contacting between the heat dissipation layer 16 and the bottom plate 10 with large area, thereby not only achieving the heat dissipation effect effectively, but also shorting the length of the heat pipe 14 to lower the space occupied by the heat pipe 14. For example, in the electronic device 1, the additional space added by the setting of the heat pipe 14 can be used to increase a resonance space of a horn (not shown) provided in the electronic device 1, thereby improving the performance of the horn. Furthermore, the electronic component 200 disposed on the circuit board 20 can be designed to align with the heat dissipation space 140. Therefore, a thermal energy generated from the electronic component 200 can be accumulated in the heat dissipation space 140, and then the thermal energy can be transmitted to outside of the electronic device 1 via the through holes 100 of the bottom plate 10.

In FIG. 2, a portion of the battery assembly 12 is disposed over the heat dissipation layer 16, and the battery assembly 12 is located outside of the heat dissipation space 140. The heat dissipation portion 144 of the heat pipe 14 is located between the heat dissipation space 140 and the battery assembly 12, and a portion where the heat dissipation portion 144 contacts the heat dissipation layer 16 is also located between the heat dissipation space 140 and the battery assembly 12. Furthermore, the heat dissipation layer 16 of the present disclosure extends from between the heat dissipation portion 144 and the bottom plate 10 to between the battery assembly 12 and the bottom plate 10, and to a side of the battery assembly 12 away from the heat dissipation portion 144. In some embodiments, the heat dissipation layer 16 can totally cover the battery assembly 12, and the battery assembly 12 can be totally disposed over the heat dissipation layer 16.

Because the heat dissipation layer 16 is disposed under the heat dissipation portion 144 of the heat pipe 14, and has a good thermal conductivity, the heat dissipation layer 16 can disperse the thermal energy of the dissipation portion 144 at least uniformly between the battery assembly 12 and the bottom plate 10 by the space therebetween. Then, the heat dissipation layer 16 can transmit the thermal energy from the bottom plate 10 to outside of the electronic device 1 via the filling material layer 11. Therefore, the housing of the electronic device 1 may have a small temperature difference at different locations thereof. When the user operates the electronic device 1, the body feel of the electronic device 1 can be more comfortable. Furthermore, because the heat dissipation portion 144 of the heat pipe 14 is located outside of the battery assembly 12 (that is, the heat pipe 14 is without surrounding the battery assembly 12) and the thermal energy absorbed by the heat pipe 14 can be transmitted at least between the battery assembly 12 and the bottom plate 10 via the heat dissipation layer 16, thereby shorting the length of the heat pipe 14 to lower the space occupied by the heat pipe 14. Therefore, the electronic device 1 of the present disclosure can increase a utilization rate of its internal space. For example, in the electronic device 1, the additional space added by the setting of the heat pipe 14 can be used to increase a volume and/or capacity of the battery assembly 12 of the electronic device 1.

Reference is made to FIG. 4. FIG. 4 a partial enlarged perspective view of the electronic device 1 in accordance with some embodiments of the present disclosure. As shown in FIG. 4, in the embodiment, the heat sink 19 of the electronic device 1 has at least one screw hole 190 (three are depicted). The electronic device 1 further includes at least one fixing member 13 (three are depicted). In the embodiment, the fixing member 13 can be a screw. Furthermore, a quantity of the fixing member 13 and the screw hole 190 of the heat sink 19 of the present disclosure is not limited thereto. The fixing member 13 is used for fixing the heat pipe 14 to the bottom plate 10 via the screw hole 190 of the heat sink 19. As such, the heat pipe 14 of the present disclosure can be fixed via the heat sink 19 and the fixing member 13 without the need for other fixing element.

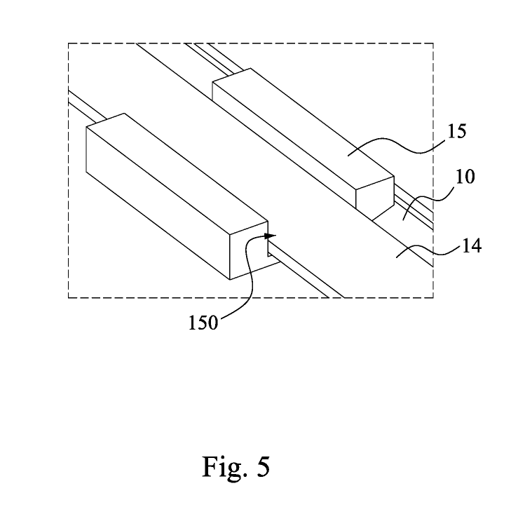

Reference is made to FIG. 5. FIG. 5 is another partial enlarged perspective view of the electronic device 1 in accordance with some embodiments of the present disclosure. As shown in FIG. 5, in the embodiment, the electronic device 1 further includes elastic structure 15. In the embodiment, the elastic structure 15 is a rubber lump, but the present disclosure is not limited thereto. The elastic structure 15 is located between the bottom plate 10 and the heat pipe 14, and has a trench 150. The heat pipe 14 is embedded in the trench 150 of the elastic structure 15. As such, the heat pipe 14 can be fixed to the bottom plate 10 via the elastic structure 15, and can be a bumper to absorb a shock. Hence, as the electronic device 1 is subjected to an external force, the elastic structure 15 prevents the heat pipe 14 from colliding with elements in the electronic device 1 and causing damage to the associated elements.

According to the foregoing recitations of the embodiments of the disclosure, it can be seen that the heat pipe of the present disclosure is designed to be a closed circuit, and the heat dissipation layer is disposed under the heat dissipation portion of the heat pipe and has a good thermal conductivity, thereby enabling the heat dissipation layer to disperse the thermal energy of the dissipation portion at least uniformly between the battery assembly and the bottom plate by the space therebetween. Therefore, the housing of the electronic device may have a small temperature difference at different locations thereof. When the user operates the electronic device 1, the body feel of the electronic device 1 can be more comfortable. Furthermore, because the heat dissipation portion of the heat pipe is located outside of the battery assembly (that is, the heat pipe is without surrounding the battery assembly) and the thermal energy absorbed by the heat pipe can be transmitted at least between the battery assembly and the bottom plate via the heat dissipation layer, thereby shorting the length of the heat pipe to lower the space occupied by the heat pipe. Therefore, the electronic device of the present disclosure can increase a utilization rate of its internal space. For example, in the electronic device, the additional space added by the setting of the heat pipe can be used to increase the volume and/or capacity of the battery assembly of the electronic device.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

1. An electronic device, comprising:
a bottom plate;
a heat pipe disposed along the bottom plate;
a battery assembly disposed on the bottom plate; and
a heat dissipation layer disposed between the heat pipe and the bottom plate and extending between the battery assembly and the bottom plate, wherein the heat pipe has a first segment and a second segment extends from the first segment and aligned between the first segment and the battery assembly in a direction.

2. The electronic device of claim 1, wherein the second segment of the heat pipe overlaps with the heat dissipation layer.

3. The electronic device of claim 1, wherein the heat pipe forms a closed loop.

4. The electronic device of claim 1, wherein the heat pipe surrounds to form a heat dissipation space within an inner circumferential edge thereof, and the battery assembly is located outside the heat dissipation space.

5. The electronic device of claim 4, wherein the bottom plate has a plurality of through holes, and the heat dissipation space is communicated to outside of the electronic device via the through holes.

6. The electronic device of claim 5, wherein the through holes are located in the heat dissipation space.

7. The electronic device of claim 6, further comprising at least one heat sink disposed between the bottom plate and the heat pipe and covering the heat pipe.

8. The electronic device of claim 7, further comprising a fixing member, wherein the heat sink has at least one screw hole, and the fixing member fixes the heat pipe to the bottom plate via the screw hole.

9. The electronic device of claim 1, further comprising an elastic structure disposed between the bottom plate and the heat pipe and having a trench, wherein the heat pipe is embedded in the trench.

10. The electronic device of claim 1, further comprising an adhesive layer adhered between the heat dissipation layer and the heat pipe.
